(19) United States
(12) Patent Application Publication
(10) Pub. No.: US 2005/0115064 A1
(43) Pub. Date: Jun. 2, 2005

(54) Shaft separation and installation kit

(76) Inventors: K. Pulohasingam, Queensland (AU); Michael Berry, Queensland (AU)

Correspondence Address: YOUNG & THOMPSON, 745 SOUTH 23RD STREET, 2ND FLOOR, ARLINGTON, VA, 22202, US

(21) Appl. No.: 10/970,007

(22) Filed: Oct. 22, 2004

(30) Foreign Application Priority Data
Oct. 23, 2003 (AU) 2003905816

(51) Int. Cl. B23P 19/00

(52) U.S. Cl. 29/801; 29/700

(57) ABSTRACT

A kit is provided for separating or connecting a splined shaft (11) to an internally splined yoke (10). The kit comprises a hydraulic cylinder assembly (12) and alignment means for axially positioning of the cylinder assembly in a pushing or pulling position relative to the yoke- and coupling means (16) to enable the hydraulic cylinder assembly to displace the shaft into or out of the yoke.

### FIELD OF THE INVENTION

This invention relates to shaft separation in drive train repair and in particular to separation of a yoke of a universal joint from a splined transmission pinion gear shaft of a differential using a hydraulic drive. While the present invention has application to a truck differential, it has general application to drive trains involving similar construction.

### BACKGROUND TO THE INVENTION

The drive shaft, or propeller shaft, connects the transmission output shaft to the differential pinion shaft. Since all roads are not perfectly smooth, and the transmission is fixed, the drive shaft has to be flexible to absorb the shock of bumps in the road. Universal, or “U-joints” allow the drive shaft to flex (and stop it from breaking) when the drive angle changes.

Drive shafts are usually hollow in order to weigh less, but of a large diameter so that they are strong. High quality steel, and sometimes aluminium, are used in the manufacture of the drive shaft. The shaft must be quite straight and balanced to avoid vibrating. Since it usually turns at engine speeds, a lot of damage can be caused if the shaft is unbalanced, or bent. Damage can also be caused if the U-joints are worn out. The Universal joint (U-joint) is used to connect the drive shaft to the transmission output shaft and the differential pinion gear shaft. This joint must be flexible enough to allow changes in the driving angle (road incline) and the drive shaft. This way, the torque is constantly transmitted when the rear axle is moving up and down.

Most universal joints employ a universal joint splined yoke. A corresponding end section of the pinion gear and transmission shaft is fitted tightly into the yoke. The fitting is very tight to avoid movement that might cause wear over time and consequently separation of the two in the workshop is often a difficult using present methods. At present the shaft and yoke are hammered apart. This involves occupational health issues due to the possibility of injury to workers and the long term effects of high noise levels. There is also the possibility of damage to serviceable parts by the hammering. Once the problems have been diagnosed, repaired or replacement parts have to be assembled using the reverse process with the same problems arising in the assembly.

It is an object of the present invention to provide a hydraulically driven solution to the separation of the shaft and yoke.

It is a further object to provide a hydraulically driven solution to the assembly of the shaft and yoke.

### OUTLINE OF THE INVENTION

In one aspect, therefore, the present invention resides in a kit for separating or connecting splined a shaft to an internally splined yoke, the kit comprising a hydraulic cylinder assembly and alignment means for axially positioning of the cylinder assembly in a pushing or pulling position relative to the yoke and coupling means to enable the hydraulic cylinder assembly to displace the shaft into or out of the yoke.

The hydraulic cylinder assembly preferably includes a hand pump so as to be manually operable. Other pumps may be used.

The alignment means typically comprises different sets of adaptors set to various manufacturers' yokes.

In the case of a pulling action, the alignment means typically includes a threaded coupling or adapter securable to the shaft when the kit is operatively configured to pull the shaft into the housing. A set of couplings is provided, each one to suit different manufacturers' yokes. Typically, a collar surrounding the adapter is used to space the cylinder assembly body from the yoke.

In the case of a pushing action, the alignment means typically comprises means to secure the ram in rigid connection to the yoke to provide purchase against the yoke for the pushing action. Since a yoke has side apertures it is convenient to use these and typically, bilaterally projecting stubs that project into the yoke side apertures are used. The kit typically includes a selection of trunnions that fit into different sized side apertures for different yoke makes.

Preferably, the collar and stubs are mounted to opposite ends of the cylinder assembly as a dedicated cylinder construction.

### BRIEF DESCRIPTION OF THE DRAWINGS

In order that the present invention may be more readily understood and be put into practical effect, reference will now be made to the accompanying drawings which illustrate one preferred embodiment and wherein:—

FIG. 1 is a perspective drawing illustrating operation of the present invention with the ram configured to pull the shaft into the yoke;

FIGS. 2 and 3 show an arrangement whereby the ram is reversed and being used to push the shaft out of the yoke;

FIGS. 4 and 5 are part sections showing the shaft being pulled into the yoke; and

FIG. 6 is a section corresponding to FIG. 5 where the ram is used to separate the shaft from the yoke.

### DETAILED DESCRIPTION OF THE DRAWINGS

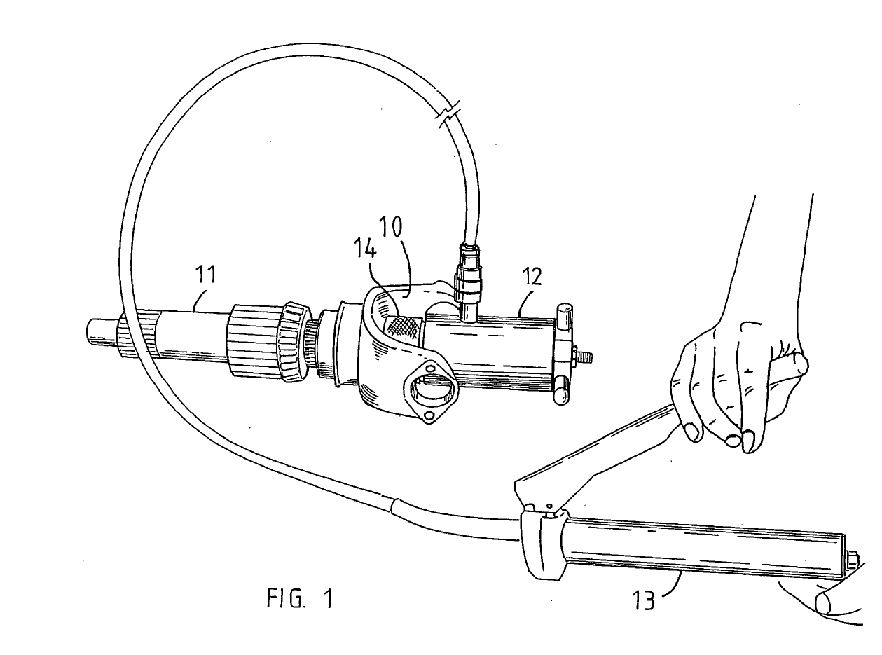

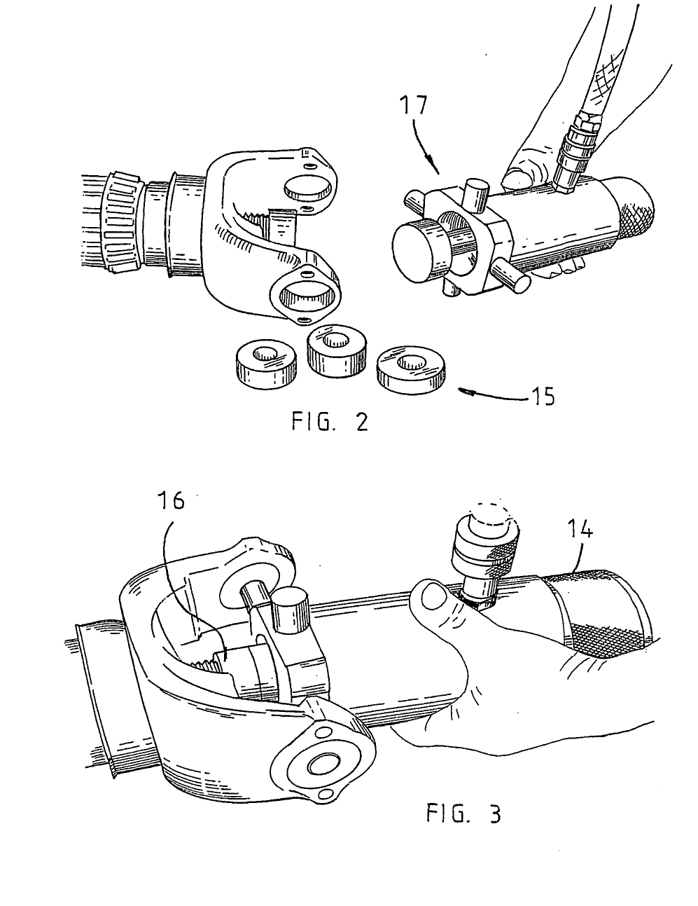

Referring to the drawings and initially to FIGS. 1 to 3, there is illustrated a yoke 10 aligned with a pinion shaft 11 and a hydraulic cylinder assembly 12 positioned to pull the shaft into the shaft housing in yoke 10.

The cylinder assembly 12 is designed with adapters to fit the yoke as part of a kit. The kit includes an hydraulic hand pump 13, a collar 14, various bushes 15 and a threaded connector 16 so that the piston rod of the cylinder assembly may be connected to the pinion shaft. The cylinder assembly has a specially configured cylinder head portion at 17 so that it may be positioned as illustrated in FIG. 3 to provide a pushing action to push the pinion shaft from the yoke.

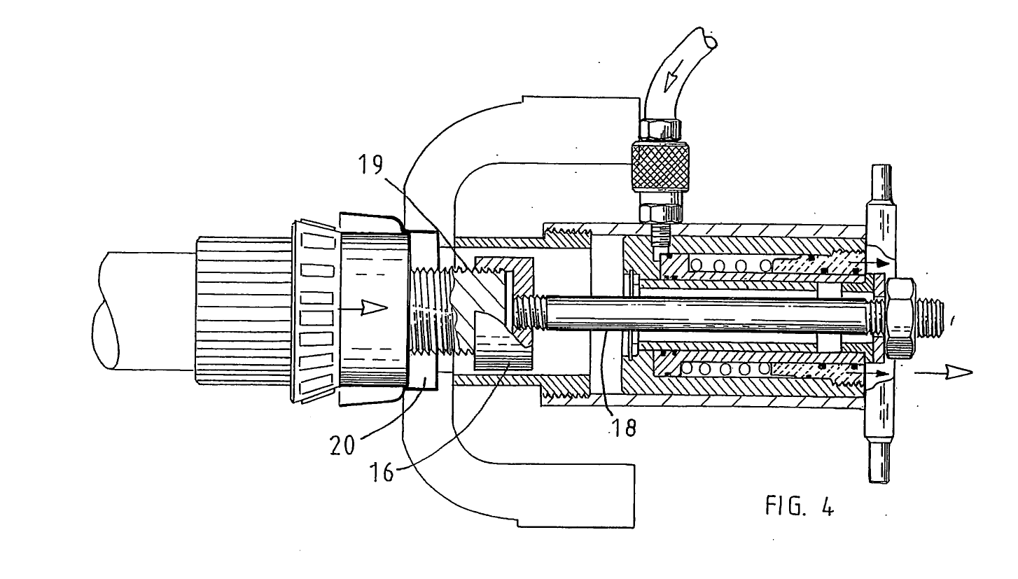

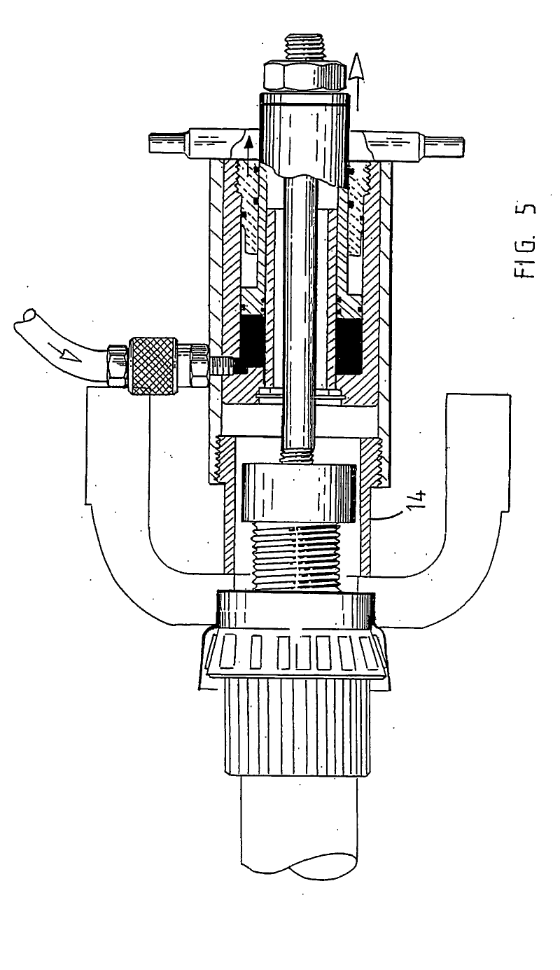

FIGS. 4 and 5 show the setup for pulling the pinion shaft into the yoke. FIG. 4 shows the threaded connector 16 that adapts the piston rod 18 to the threaded section 19. Adaptors 16 are provided to suit different threaded sections 19 in the commercially available pinion shafts. FIG. 4 shows the hydraulic cylinder assembly in the fully retracted position whereas FIG. 5 shows the piston extended and the shaft drawn into the shaft housing 20.

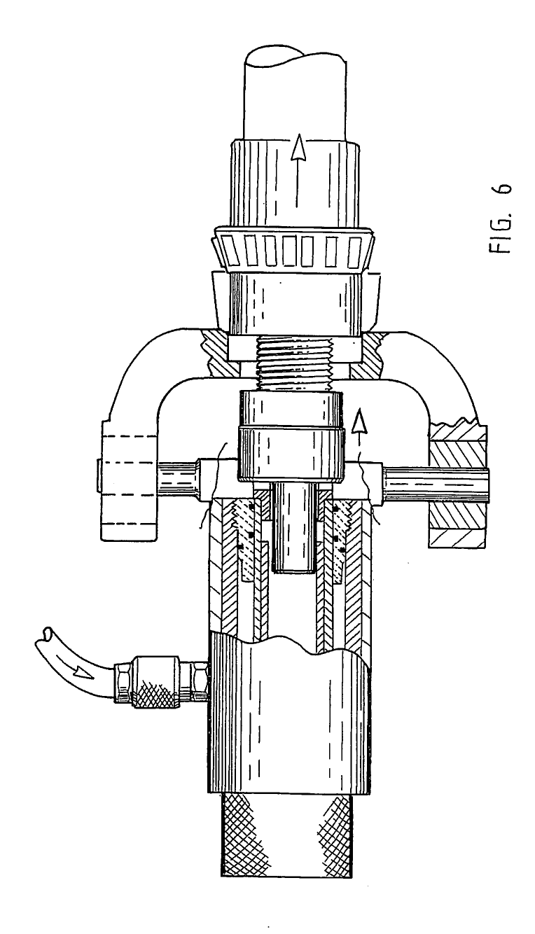

In order to separate the shaft from the yoke, the cylinder assembly is reversed and set up as shown in FIG. 3 and, as can be seen in FIG. 6, the shaft is pushed from the yoke.

Whilst the above has been given by way of illustrative example of the present invention many variations and modifications thereto will be apparent to those skilled in the art without departing from the broad ambit and scope of the invention as herein set forth.

1. A kit for separating or connecting a splined shaft to an internally splined yoke, the kit comprising a hydraulic cylinder assembly, alignment means for axially positioning of the cylinder assembly in a pushing or pulling position relative to the yoke, and coupling means arranged to enable the hydraulic cylinder assembly to displace the shaft into or out of the yoke; the alignment means having different sets of adaptors configured to suit various yoke sizes.

2. The kit according to claim 1 wherein the hydraulic cylinder assembly including a manually operable pump for operating the assembly.

3. The kit according to claim 1 wherein in the case of a pulling action, the yoke having a housing and each adaptor is a threaded coupling securable to the shaft when the kit is operatively configured to pull the shaft into the housing.

4. The kit according to claim 1 wherein said cylinder assembly having a body, and a collar is arranged to surround an adapter secured to said shaft and to space the body from the yoke.

5. The kit according to claim 1 wherein in the case of a pushing action, the cylinder assembly having a ram and the alignment means having means to secure the ram in rigid connection to the yoke to provide purchase against the yoke for the pushing action.

6. The kit according to claim 4 wherein the yoke having side apertures, and the cylinder assembly having bilaterally projecting stubs arranged to project into the yoke side apertures.

7. The kit according to claim 6 further comprising a selection of trunnions that fit into different sized side apertures.

8. The kit according to claim 6 wherein the collar and stubs are mounted to opposite ends of the cylinder assembly.
